(19) United States
(12) Patent Application Publication
(10) Pub. No.: US 2011/0302089 A1
(43) Pub. Date: Dec. 8, 2011

(54) ELECTRONIC CREDIT CARD WITH FRAUD PROTECTION

(76) Inventor: Craig McKenzie, Los Angeles, CA (US)

(21) Appl. No.: 12/794,026

(22) Filed: Jun. 4, 2010

(51) Int. Cl. G06Q 40/00; G06K 19/06; G06K 7/10; H04L 9/32

(52) U.S. Cl. 705/75; 235/380; 705/44

(57) ABSTRACT

A method for verifying permission to use a payment system such as an electronic credit card, using a hand held communication device such as a smart phone, where the customer presents the communication device to a merchant who extracts account information from the hand held device, and the merchant sends a request for identification verification information to be sent to the hand held communication device directly or to an alternate display. The verification information can be in the form of a photograph, fingerprint, or the like. The merchant can then compare the identification verification data to the customer to determine if the customer is authorized to used the account according to the request.

### BACKGROUND

Smartphone sales in the first quarter of 2010 grew by nearly 49% compared with the first quarter a year ago, the biggest year-on-year increase since 2006, a recent study reported. That rate of growth put smartphones at 17.3% of all mobile phones sold in the first quarter (54.3 million out of 314.6 million) up from 13.6% in the first quarter of 2009. This proliferation of new generation smart phones, such as Apple's iPhone, has led to many new developments in fields that can benefit from the power and proliferation of these devices. One such field is the retail market, and in particular methods of payment for services and merchandise using these smart phones.

There have been many attempts to capitalize on this concept by introducing the concept of an electronic credit card that can be implemented with a smart phone. For example, using the phone a consumer can present the phone to a merchant at a point of purchase, and display a bar code or other identifier that can be used by the merchant to debit the customer's account. For example, Labrou et al., U.S. Patent Publication. 2007/0022058, discloses a mobile device such as a phone or PDA that can be used to conduct a point of sale (POS) transaction using a wireless network. Labrou discusses the use of barcode generated by the mobile phone and read by the merchant to authorize payment. Guest et al., U.S. Patent Publication. 2009/0222353, discloses a mobile credit device where the display of the mobile telephone is used to display an image including a barcode which graphically represents transaction data. This includes data identifying a transaction data base records in a transaction database, the transaction database records including data identifying the mobile radio apparatus account. The system is used for an electronic payment device using a phone or PDA, where an image or barcode is generated and read by the merchant to confirm a transaction. Steinberg, U.S. Patent Publication. 2009/0222459, discloses a method, system, apparatus and computer code to consolidate one or more pieces of information onto an electronic device for later conveyance via wireless transmission, display in human readable form, and/or display in computer readable form. The invention seeks to consolidate multiple credit cards, membership cards, tickets, coupons, and other items which can all be represented electronically on a single device. Other disclosures include that of U.S. Patent Publication. 2009/0261166 to Lawson et al., U.S. Patent Publication. 2009/0299834 to Wilson, U.S. Patent Publication. 2009/0156180 to Slavin et al., U.S. Patent Publication. 2010/0063872 to Patel et al., and U.S. Patent Publication. 2010/0070364 to Dugan. Applicant hereby incorporates by reference each and every disclosure of the references above in their entirety into the present application.

While the above disclosures have shown that there is a need for electronic credit cards and the convenience they provide, not enough attention has been applied to the concept of security and fraud protection. In today's increasingly electronic society and with the rapid advances of electronic commerce on the Internet, the use of credit cards for purchases has become convenient and necessary. Credit card transactions have become the de facto standard for Internet and Webbased e-commerce. However, the growing number of credit card transactions provides more opportunity for thieves to steal credit card numbers and subsequently commit fraud. When banks lose money because of credit card fraud, cardholders pay for all of that loss through higher interest rates, higher fees, and reduced benefits. Hence, it is in both the banks' and the cardholders' interest to reduce illegitimate use of credit cards by early fraud detection. The use of electronic credit cards present a new opportunity to address this aspect of credit card purchases.

### SUMMARY OF THE INVENTION

The present invention utilizes the access ability of the smart phone to protect against credit card fraud by having the lending institution or financial institution, rather than the customer or card-holder, provide instant identification to the merchant as to the authorization of the card holder to make a purchase. For example, a customer can present a smart phone with an application running that includes an “electronic credit card.” Having selected an item to purchase, the customer activates the application which displays on the smart phone's screen machine readable information such as a bar code or the like that identifies the card holder's account and financial institution. The merchant can read this information using a scanner or other means for reading the bar code, etc. The merchant can then request that the smart phone send a request for authorization directly to the lending institution at the time of purchase. Alternatively, the merchant can send a request through a separate channel to the lending institution outside of the smart phone. When the request is made, the lending institution can provide status on the account (good standing, frozen, fraud alert, etc.) and verify credit limits or account balances if requested. The lending institution can also cause to be displayed on the smart phone in a preferred embodiment, or on a separate screen in another embodiment, identification delivered from the lending institution in the form of a photograph, fingerprint identification, retina scan, or other identification information that positively identifies the person standing before the merchant as the authorized user. Because the identification comes from the lending institution, it cannot be tampered with or otherwise hacked by a user who has stolen the smart phone or is not authorized to use the account. The information can further be verified by an encryption key that allows the merchant to verify the information is from the lending institution. With the identification information, the merchant can compare the data (photo, fingerprint, etc.) and determine if it is safe to proceed with the transaction. In this way, the merchant and the account holder are protected from unauthorized use of the account.

### BRIEF DESCRIPTION OF THE DRAWINGS

FIG. 1 a schematic view of a method for carrying out the present invention; and

FIG. 2 is a flow diagram of the method of the present invention.

### DETAILED DESCRIPTION OF THE PREFERRED EMBODIMENTS

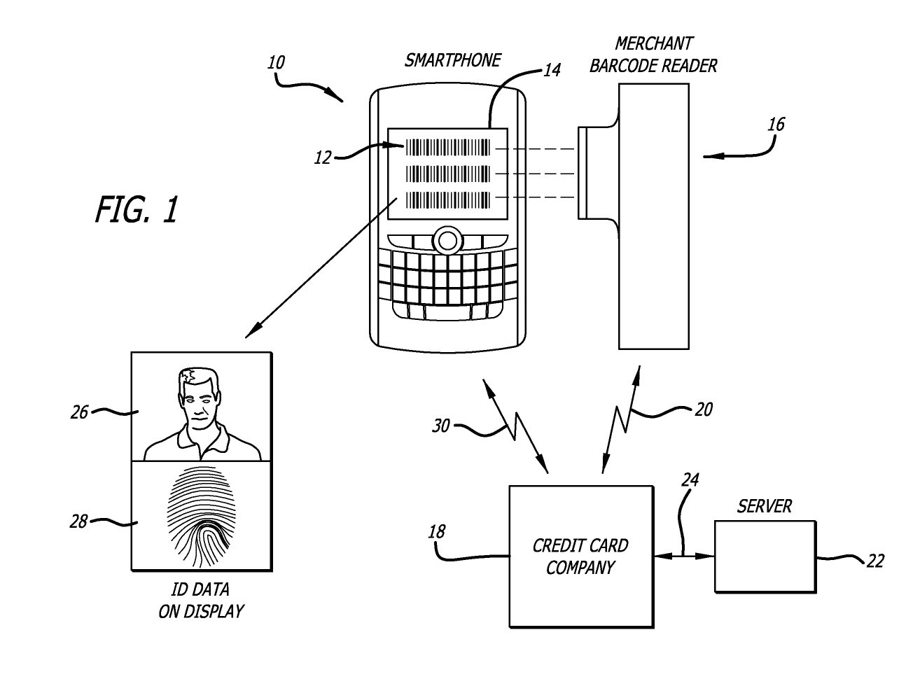

FIG. 1 is a schematic diagram of the method of the present invention. The method involves the verification of the identification of a user of an electronic credit card. In order to carry out the invention, the customer will present a smartphone 10 such as an Apple iPhone™ or any of the other popular smartphones on the market that can run applications such as the type described here. When the customer is ready to make a purchase, the customer will activate an application on the phone 10 to cause a machine readable code such as a bar code 12 to be displayed on the screen 14 of the phone 10. The bar code 12 encodes information regarding an account of the customer for use in paying a merchant as part of the contemplated transaction. The merchant then uses an instrument such as, for example, a scanner or bar code reader 16 to read the bar code 12 and extract the customer's account information. The account information could be, for example, a credit card number, expiration date, customer name and address, credit card company and contact information, and account balance or credit limit.

The merchant can extract that information and verify that the account is a valid account and that the transaction does not conflict with any guidelines, credit limits, balances, etc. That is, if the cost of the transaction exceeds the credit limit on the account, the merchant may choose to terminate the transaction. However, if the transaction is otherwise approved, it is still desirable to verify the identify of the customer to make sure the individual present before the merchant is the authorized user of the account. The present invention serves this purpose.

Once the transaction has been conditionally approved, the merchant establishes contact with the credit card 18 company electronically, telephonically, or in another manner requesting that the credit card company cause to be displayed on the phone 10 identification verification information as to the identity of the authorized customer on the account. This request, represented by arrow 20 in FIG. 1, may be derived from information obtained from the bar code 12 (such as a special telephone number, access code, data link protocol, or the like). However, in a preferred embodiment the contact information and protocol to establish the request is established a priori independent of the customer's information to eliminate a potential avenue for fraud. That is, if the link between the credit card company 18 (or bank, lending institution, or any other account verification entity) is accessed solely through information obtained from the phone 10 then there is the opportunity for a thief or non-authorized personnel to obtain the phone without permission, hack into the application software, and direct the merchant to a phony location that will authorize the thief. If, on the other hand, the merchant and the credit card company 18 have an independent pre-arranged protocol then there is no way for a thief to circumvent the verification process.

When the merchant sends the request 20 to the credit card company 18, the credit card company 18 accesses a customer data server 22 that stores the customer information, and access the information specific to that account. This information is established beforehand when the account is opened or the application for the smart phone is activated, and may be for example a photograph stored in digital format, a fingerprint stored in digital format, and retina scan, or other physiological characteristic of the authorized user that would be challenging to mimic. Alternatively, the verification information could be a numerical or alphanumeric sequence known only to the authorized customer. The credit card company retrieves the requested verification date through the link 24, and in a preferred embodiment forwards the information to the phone 10 via an electronic link 30. In the case of a photograph, the image 26 of the authorized user is displayed on the phone's display 14, which can be readily verified by the merchant. If the verification data is in the form of a fingerprint, the phone uses its scanning capability to scan the customer's fingerprint in the presence of the merchant, and then compares the scanned fingerprint 28 with the information corresponding to the authorized customer's fingerprint data using known technology for comparing fingerprints. Other verification data types, such as retina scan, voice recognition, etc are also within the scope of the present invention.

Alternatively, the photograph, fingerprint, or other identification data can be sent to the merchant at a separate display location, such as an liquid crystal display screen (not shown) near the register. In this alternate embodiment, the hand held device is not used to verify the identification, although it can be used to send the request for identification to the lending institution. The lending institution may also send out a “ping” to the account holder's phone to verify the GPS data of the authorized phone. If the authorized phone is at a location other than the merchant's location, the merchant may assume that the customer's phone is either stolen or the authorized user's data has been stolen, and that further investigation at the least is warranted.

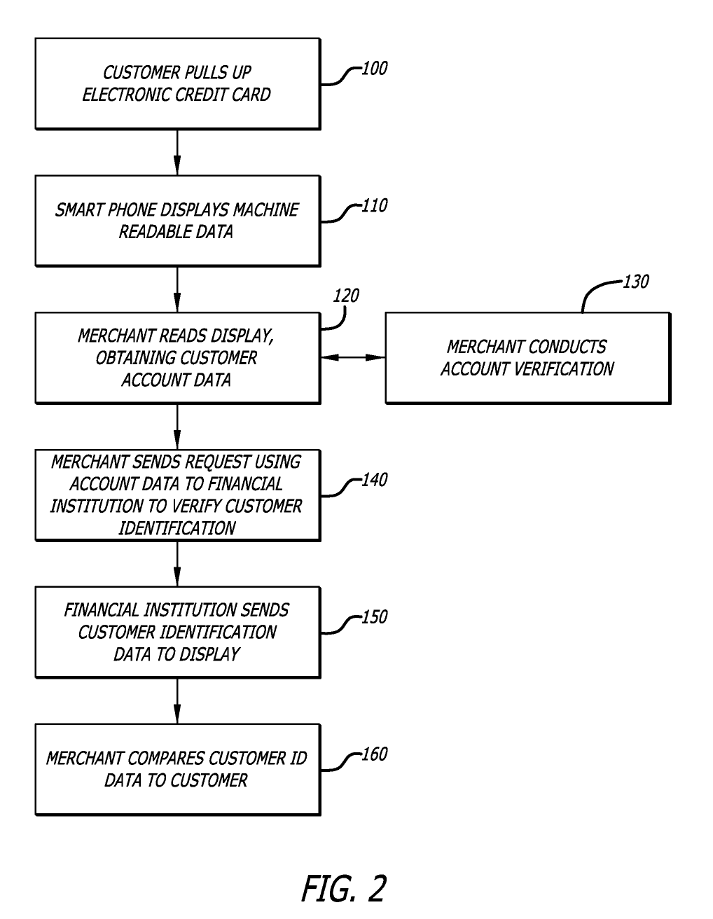

FIG. 2 is a flow diagram of the steps that may be used in conjunction with the present invention. Box 100 represents the step of the customer activating the application on the smart phone 10, followed by the displaying of the machine readable data in box 110 corresponding to the account information identifying the customer's bank account, credit card information, or the like. Once the information is displayed in a machine readable format, box 120 represents the merchant reading the machine readable information using a bar code scanner, optical recognition means, or other known method of reading the data from the customer's phone display. The merchant may then use the account information to conduct a screening or other account verification process as indicated in box 130, which may include verification that the account is active and in good standing, or that the account does not have any limitations or preconditions that are implicated by the transaction. This verification is routinely conducted with current credit card or debit card transactions.

Once the account verification process is completed, the merchant then sends a request directly to the credit card company in box 140. It is to be understood that the term “credit card company” is used for convenience, but that the entity contacted by the merchant may be a bank, lending institution, or security company used by the credit card company to perform the functions described herein. The request sent by the merchant is preferably conducted without the customer's phone so as to preserve the independence of the security process. The request may come in the form of a digital command to send data to the customer's phone, along with the customer's personal information, phone number or e-mail account, or other contact information. The request may also request that a particular type of identification data be transmitted to the phone, such as a photograph. The command may also be oral, if the request is sent telephonically by the merchant to an individual although in many cases an automated system is preferable. The request may be made directly by the bar code reader 16 as part of a larger system having a processor and data communication devices, or the request may be made by another device initiated by the merchant.

Box 150 corresponds to the fulfillment of the merchant's request, where the credit card company extracts verification information stored in a server or other electronic data storage device that is associated with the electronic credit card account, and sends the verification information to the customer's phone 10. In a preferred embodiment, the verification information is electronic data corresponding to a photograph 26 of the authorized user on the account, which can be used by the phone 10 to display the photograph 26 on the display 14. Other types of information can include a fingerprint 28 of the authorized customer, a retina scan, a voice recognition pattern, or the like. In the case of a voice recognition, the customer would be required to speak into the phone's microphone, whereupon software in the phone's application would compare the voice sample with the authorized voice pattern to determine a match. In the case of a photograph, the merchant would compare the photograph sent by the credit card company with the customer to verify the customer's authorization to use the account. This is an advance over providing a driver's license or the like, which can be doctored or forged. Here, the information comes directly from the credit card company, which has a very real interest in eliminating fraud and verifying the user's identity. In the manner, the present invention provides a cost effective, fraud resistant method for verifying the identity of the customer at the time of purchase.

The identification data may also include an encryption key that is established between the merchant and the lending institution to verify the validity of the data requested. The key may be alphanumeric, bar code, or other types of keys that are known in the art. In this way, the merchant can be confident that the data is actually from the lending institution and that the identification information is valid.

The foregoing description and the figures referenced therein are merely illustrative of the invention. Those of ordinary skill in the art will readily recognize that other variations are available and can be substituted for the particular steps described above. Therefore, nothing in the foregoing description should be taken as limiting the invention to a particular step or method of verification. Rather, the scope of the invention is properly measured by the appended claims, giving the words therein their ordinary and customary meaning as interpreted using the foregoing description for context.

1. A method for verifying an identification of a customer by a merchant using a hand held communication device, comprising:
causing to be displayed on the hand held communication device machine readable code corresponding to an account by which a payment may be made to the merchant by the customer;
reading the machine readable code, and extracting account information;
sending a request for verification data by the merchant to a credit card company where said request is made without the hand held communication device, said request including customer account data;
retrieving identification verification data by the credit card company corresponding to the account;
sending identification verification data from the credit card company to said hand held communication device; and
using said identification verification data to authenticate an identity of the customer and provide authorization to make the payment.

2. The method for verifying an identification of claim 1 wherein the identification verification data corresponds to a photograph of an authorized user of the account.

3. The method for verifying an identification of claim 1 wherein the identification verification data corresponds to an image of a fingerprint of an authorized user of the account.

4. The method for verifying an identification of claim 1 wherein the hand held communication device is a telephone.

5. The method for verifying an identification of claim 1 wherein the request for verification data is sent to a credit card company.

6. The method for verifying an identification of claim 1 wherein the request for verification data is sent to a financial institution.

7. The method for verifying an identification of claim 1 wherein the request for verification data is sent to a third party designated to store and transmit upon request account verification data.

8. The method for verifying an identification of claim 1 wherein the machine readable code is a bar code.

9. The method for verifying an identification of claim 8 wherein the merchant uses a bar code scanner to read the machine readable code.

10. The method for verifying an identification of claim 1 wherein the identification verification data is stored on a server.

11. The method for verifying an identification of claim 1 further comprising sending an encryption key with the identification verification data that is decoded by the merchant to verify an origination of the identification verification data.
